(19) United States
(12) Patent Application Publication
(10) Pub. No.: US 2011/0214772 A1
(43) Pub. Date: Sep. 8, 2011

(54) SPIRAL HOSE

(76) Inventor: Ju Hwan LEE, Busan (KR)

(21) Appl. No.: 12/716,952

(22) Filed: Mar. 3, 2010

(51) Int. Cl. F16L 11/04

(52) U.S. Cl. 138/129

(57) ABSTRACT

The present invention provides a spiral hose comprising: a main body made of a soft synthetic resin material and wound in a spiral shape; and a reinforcing core having an elliptical sectional shape made of a hard synthetic resin material and embedded in a spiral shape into the main body so that the entire wall of the main body has a reduced thickness.

### BACKGROUND OF THE INVENTION

(a) Field of the Invention

The present invention relates to a spiral hose adapted for use for a variety of purposes in households or various industrial fields, and more particularly to such a spiral hose which includes a main body made of a soft synthetic resin material and a reinforcing core having an elliptical sectional shape made of a hard synthetic resin material and embedded in a spiral shape into the main body so that the spiral hose can be manufactured at a stable cost to achieve economic efficiency while having a pressure-resistant property in which the spiral hose can endure both the internal pressure and the external pressure thereof.

(b) Background of the Related Art

A hose used for intake and drainage purposes is classified into a straight tubular hose and a spiral hose. The spiral hose has been developed to complement a problem involved in the straight tubular hose, i.e., a problem in which the straight tubular hose is susceptible to the internal pressure thereof. The spiral hose is constructed in such a fashion such that the straight tubular hose is wound in a spiral shape to take a cylindrical shape having a circumferential wall.

However, if the spiral hose is made of only a soft synthetic resin material, it is susceptible to the external pressure and the internal pressure thereof, thus causing any problems.

In order to address such a problem, a spiral hose structure has been developed in which a hard member made of a hard synthetic resin material is embedded in a spiral shape into a main body made of a soft synthetic resin material. However, such a spiral hose encounters a shortcoming in that since the hard member has a circular sectional shape, the entire wall of the main body has an unnecessarily increased thickness, thereby leading to a waste of materials and an increase in the manufacturing cost. In addition, the spiral hose involves a drawback in that an increase in the total weight of the hose causes an inconvenience to a user during the carriage and operation of the hose.

### SUMMARY OF THE INVENTION

Accordingly, the present invention has been made to solve the above problems occurring in the prior art, and it is an object of the present invention to provide a spiral hose which can be manufactured at a stable cost to achieve both economic efficiency and commerciality while having a pressure-resistant strength in which the spiral hose can endure both the internal pressure and the external pressure thereof.

To achieve the above object, the present invention provides a spiral hose including: a main body made of a soft synthetic resin material and wound in a spiral shape; and a reinforcing core made of a hard synthetic resin material and having an elliptical sectional shape, the reinforcing core being embedded in a spiral shape into the main body so that the entire wall of the main body has a reduced thickness.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view illustrating a spiral hose according to the present invention;

FIG. 2 is a cross-sectional view taken along the line I-I of FIG. 1;

FIG. 3 is an enlarged view of a portion A of FIG. 2;

FIG. 4 is an enlarged view illustrating a state in which the reinforcing core of FIG. 3 has a truly circular sectional shape; and

FIG. 5 is a view illustrating the comparison between the elliptical sectional shape and the truly circular sectional shape of the reinforcing core included in the spiral hose.

### DETAILED DESCRIPTION OF THE PREFERRED EMBODIMENT

Hereinafter, a preferred embodiment of the present invention will be described in further detail with reference to the accompanying rawings.

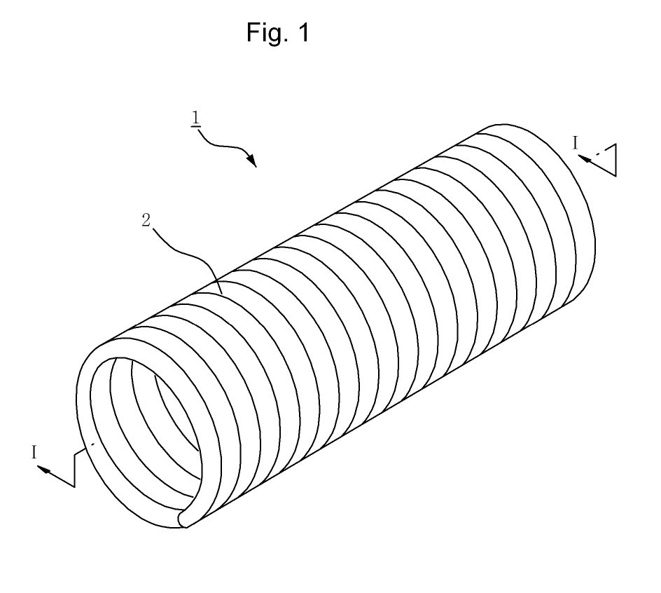

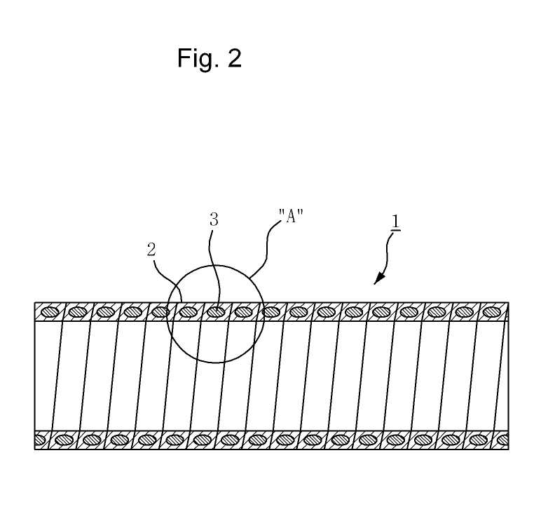

As shown in FIGS. 1 to 3, a spiral hose 1 according to the present invention is constructed such that it includes a main body 2 made of a soft synthetic resin material and wound in a spiral shape, and a reinforcing core 3 made of a hard synthetic resin material and embedded in a spiral shape into the main body 2 so that the spiral hose 1 can have a pressure-resistant property in which the spiral hose can endure both the internal pressure and the external pressure thereof.

Like this, since the reinforcing core 3 made of hard synthetic resin material is embedded into the main body 2 made of a soft synthetic resin material, it serves as a framework which allows the spiral hose to have a pressure-resistant property as well as maintain the shape of the spiral hose 1. That is, since the main body 2 is made of a soft synthetic resin material, it does not maintain its own shape well due to the characteristics of the soft synthetic resin material. But it is possible to form a spiral hose 1 having flexibility and pressure-resistant strength with the aid of the reinforcing core 3 made of a hard synthetic resin material embeddedly installed in a spiral shape inside the main body 2.

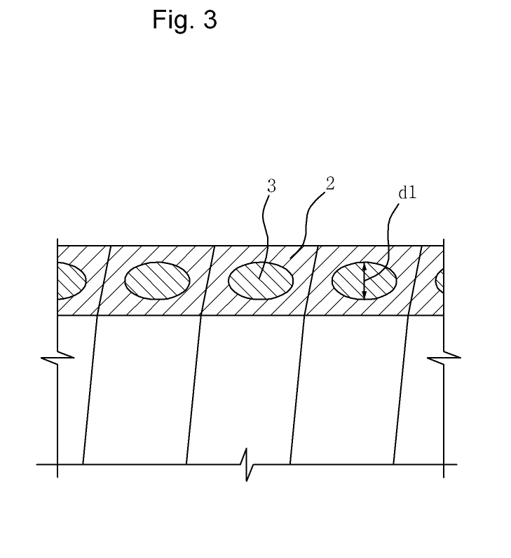

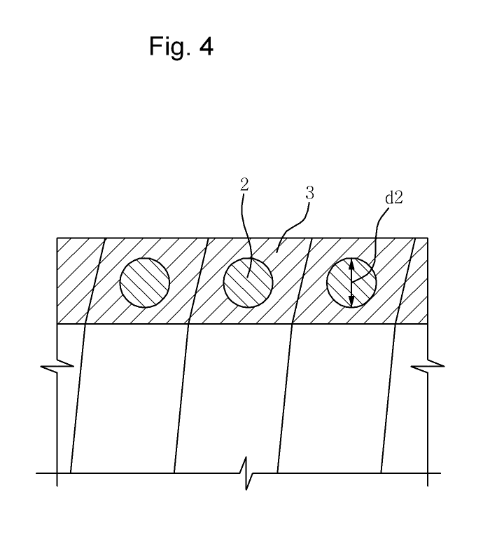

Moreover, the reinforcing core 3 made of a hard synthetic resin material according to the present invention is embedded into the main body 2 to have an elliptical sectional shape so that the entire wall of the main body 2 has a reduced thickness. In other words, the reinforcing core 3 is embedded into the main body 2 in such a fashion that the major axis (d) of the elliptical section of the reinforcing core 3 is oriented horizontally and the minor axis (d1) of the elliptical section of the reinforcing core 3 is oriented vertically so that the thickness of the entire wall of the spiral hose can be reduced, which is shown in detail in FIGS. 3 and 4.

FIG. 3 shows a state in which the reinforcing core made of a hard synthetic resin material has an elliptical sectional shape, and FIG. 4 shows a state in which the reinforcing core made of a hard synthetic resin material has a truly circular sectional shape according to the prior art. As shown in FIGS. 3 and 4, since the minor axis (d1) of the elliptical section of the reinforcing core is smaller than the diameter (d2) of the truly circular section of the reinforcing core, the thickness of the hose is reduced.

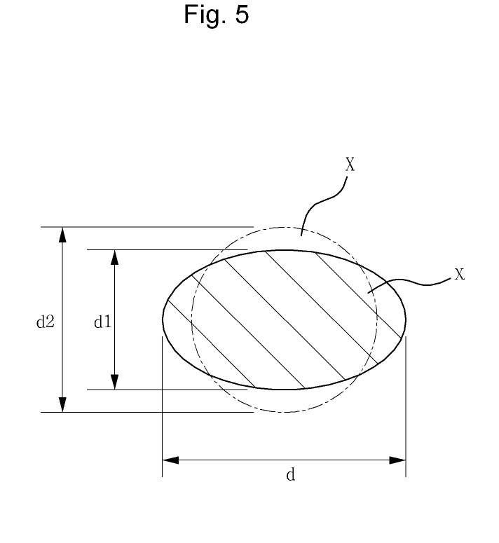

According to the present invention, in the case where the reinforcing core 3 made of a hard synthetic resin material is formed in both a truly circular sectional shape and an elliptical sectional shape, the portions of the main bodies of a soft synthetic resin material, which are positioned directly below the reinforcing cores 3, are the same in thickness. Besides, the cross-sectional area of the truly circular reinforcing core 3 is the same as that of the elliptical reinforcing core 3. That is, it can be seen through the comparison in FIG. 5 that the elliptical cross-sectional area (x) and the truly circular cross-sectional area (X) are the same as each other.

Through the comparison between FIGS. 3 and 4, it can be seen that when the reinforcing core 3 has an elliptical sectional shape rather than a truly circular sectional shape, the thickness of the entire wall of the hose is reduced. Thus, when the reinforcing core 3 has an elliptical sectional shape, the thickness of the entire wall of the main body made of a soft synthetic resin material is reduced, thereby leading to a decrease in the amount of raw materials used. Namely, the thickness of the wall of the hose can be reduced by the height of the elliptical reinforcing core reduced

Further, according to the present invention, since the main body made of a soft synthetic resin material is susceptible to the external pressure but the reinforcing core 3 made of a hard synthetic resin material is resistant to the external pressure, a pressure-resistant property in which the spiral hose can endure both the internal pressure and the external pressure thereof can be made equal to that in the reinforcing core 3 having a truly circular sectional shape while reducing the thickness of the entire wall of the hose by allowing the reinforcing core 3 to have an elliptical sectional shape.

As described above, the present invention has advantageous effects that the cross-sectional shape of the reinforcing core made of a hard synthetic resin material embedded into the main body made of a soft synthetic resin material to reinforce the spiral hose is improved from a truly circular shape to an elliptical shape, so that since the thickness of the entire wall of the main body can be made thin, the amount of the raw materials used is reduced, thereby achieving both economic efficiency and commerciality through a reduction in the manufacturing cost.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A spiral hose (1) comprising:
a main body (2) made of a soft synthetic resin material and wound in a spiral shape; and
a reinforcing core (3) made of a hard synthetic resin material and having an elliptical sectional shape, the reinforcing core being embedded in a spiral shape into the main body so that the entire wall of the main body has a reduced thickness.
